(19) United States
(12) Patent Application Publication
(10) Pub. No.: US 2006/0268548 A1
(43) Pub. Date: Nov. 30, 2006

(54) LED lighting device with light converging effect

(75) Inventor: Hsiang-Chun Chang, Taichung (TW)

Correspondence Address: PATENTTM.US, P. O. BOX 82788, PORTLAND, OR, 97282-0788, US

(73) Assignee: HAOLI PRECISION INDUSTRIAL CO., LTD.

(21) Appl. No.: 11/138,930

(22) Filed: May 25, 2005

(51) Int. Cl. F21V 13/04

(52) U.S. Cl. 362/245; 362/241

(57) ABSTRACT

An LED lighting device with light converging effect has a circuit board with multiple LEDs, a light converging base and a cover. The light converging base is securely connected to the circuit board and has multiple reflecting cavities defined in the light converging base. Each reflecting cavity has a bore defined in a bottom of the reflecting cavity and corresponding to and receiving one of the LEDs. Each cavity has a depth larger than a length of the corresponding LED. The cover is combined with the light converging base to enclose the LEDs.

### BACKGROUND OF THE INVENTION

1. Field of the Invention

The present invention relates to a composition of a lighting device using multiple light emitting diodes (LEDs) as light sources, and more particularly to a LED lighting device having light converging effect to enhance the luminous intensity of the lighting device in a certain direction.

2. Description of Related Art

Because of its high energy efficiency, long product life, and environmental friendly materials, the light emitting diode (LED) has become more and more popular as a light source in many applications. In one sort of applications thereof, the LED is used in illuminating lights, such as headlights of cycles and automobiles, and flashlights, in which the light emitted from the LED has to be converged to enhance the luminous intensity in the frontward direction so that objects in front of the users can be illuminated and seen clearly.

With reference to FIGS. 4 to 6, a first conventional LED lighting device with light converging effect is securely received within a casing, and has a circuit board (41) with multiple LEDs (44) mounted thereon, a reflection plate (42) and a transparent cover (43) with multiple integrated lenses (45), each lens hereof corresponding to one individual LED (44). The reflection plate (42) has an arcuate front edge and multiple reflecting cavities defined in the arcuate front edge and respectively corresponding to and receiving the LEDs (44). A portion of the light emitted sidewards from the LEDs (44) is reflected by the reflecting cavities of the reflection plate (42).

The frontward light emitted from this lighting device is composed of the light emitted frontwards directly from the LEDs (44) and the light reflected frontwards by the reflection plate (42). The more the frontward light, the higher the luminous intensity in the frontward direction. But, in such a device, a significant portion of the light from the LEDs (44) is scattered sidewards, as shown in FIG. 5, upwards and downwards, as shown in FIG. 6, and thus weakens the luminous intensity in the frontward direction.

A second conventional LED lighting device with light converging effect is shown in FIG. 7 and has a circuit board (51), a substrate (52), multiple LEDs (53), multiple cylinders (54) and a cover (55). The substrate (52) is securely attached to the circuit board (51). The LEDs (53) are mounted on the substrate (52). The cylinders (54) are hollow, and each corresponds to and encloses one of the LEDs (53). Each hollow cylinder (54) has a closed end with an integrated lens (56). The cover (55) is securely connected to the substrate (52) to enclose the hollow cylinders (54) as well as the LEDs (53). However, due to the cylindrical configuration of the hollow cylinders (54), the efficiency of the cylinders (54) to reflect the light emitted from the LEDs (52) is poor. Second, because the cylinders (54) are made of a transparent material, a portion of the light emitted from the LEDs (52) will be lost sidewards through the side faces of the hollow cylinders (54). Third, after the frontward light passes through the integrated lenses (56) of the hollow cylinders (54), it has to pass through the cover (55), which weakens the luminous intensity of this lighting device due to transmission loss. Additionally, the production cost of this lighting device is relatively expensive because of its complicated structure.

To overcome the shortcomings, the present invention intends to provide an LED lighting device having enhanced light converging effect with a simple and efficient composition to mitigate the aforementioned problems.

### SUMMARY OF THE INVENTION

The primary objective of the present invention is to provide an LED lighting device that can avoid light loss and converge light to enhance the luminous intensity in a certain direction. The LED lighting device has a circuit board with multiple LEDs, a light converging base and a cover. The light converging base is securely connected to the circuit board and has multiple reflecting cavities defined in the light converging base. Each reflecting cavity has a bore defined in a bottom of the reflecting cavity and corresponding to and receiving one of the LEDs. The depth of the reflecting cavities are larger than the length of the LEDs. The cover is combined with the light converging base to enclose the LEDs.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of an LED lighting device with light converging effect in accordance with the present invention;

FIG. 2 is an exploded side plan view in partial cross section of the lighting device in FIG. 1;

FIG. 3 is a side plan view in partial cross section of the lighting device in FIG. 1;

FIG. 4 is a perspective view of a light in which installed a first conventional LED lighting device in accordance with the prior art;

FIG. 5 is a top plan view in partial cross section of the conventional LED lighting device along line 5-5 in FIG. 4;

FIG. 6 is a side plan view in partial cross section of the conventional LED lighting device along line 6-6 in FIG. 4; and

FIG. 7 is an exploded perspective view of a second conventional LED lighting device in accordance with the prior art.

### DETAILED DESCRIPTION OF THE PREFERRED EMBODIMENT

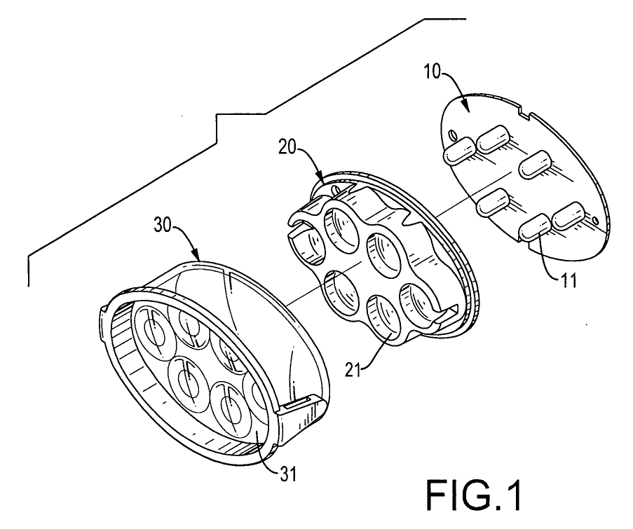

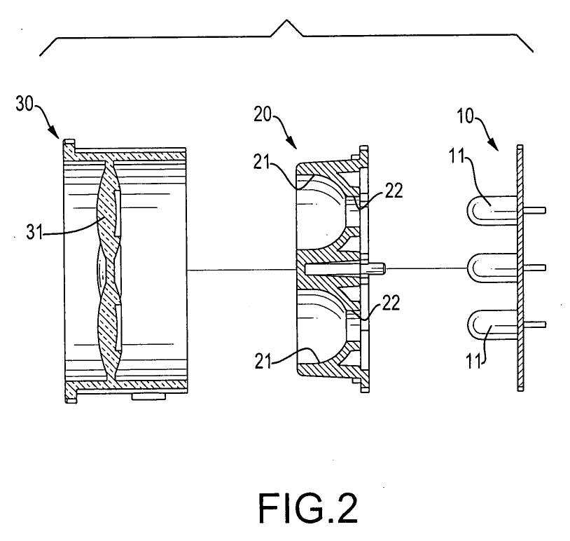

With reference to FIGS. 1 and 2, a lighting device in accordance with the present invention is installed in the casing and comprises a circuit board (10), a light converging base (20) and a cover (30).

The circuit board (10) has multiple LEDs (11) mounted thereon. The light converging base (20) has multiple reflecting cavities (21) defined on the light converging base (20) and each having an opening. In addition, multiple bores (22) are defined in bottoms of the reflecting cavities (21) to correspond to and receive the LEDs (11). Each cavity has a depth larger than a length of the corresponding LED. The cover (30) is cylindrical in shape and has multiple integrated lenses (31) formed therein to correspond to the reflecting cavities (21).

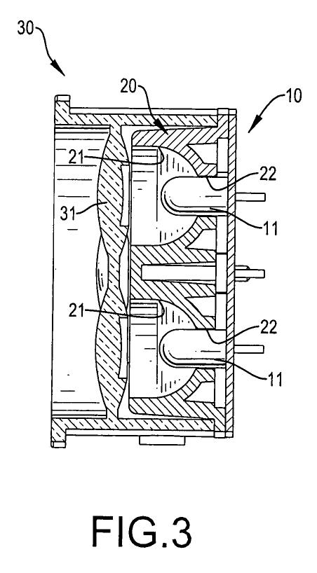

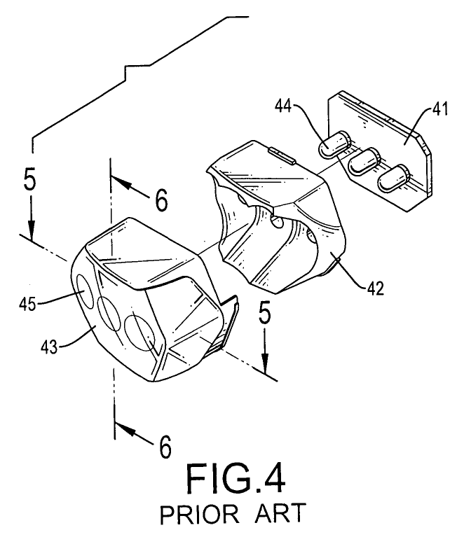

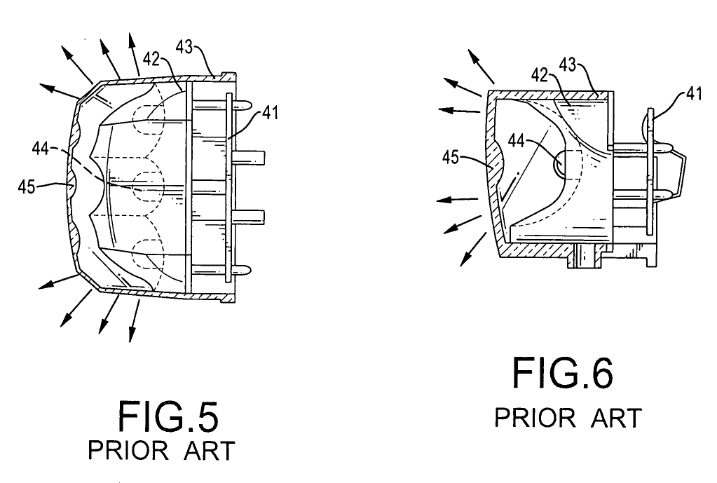

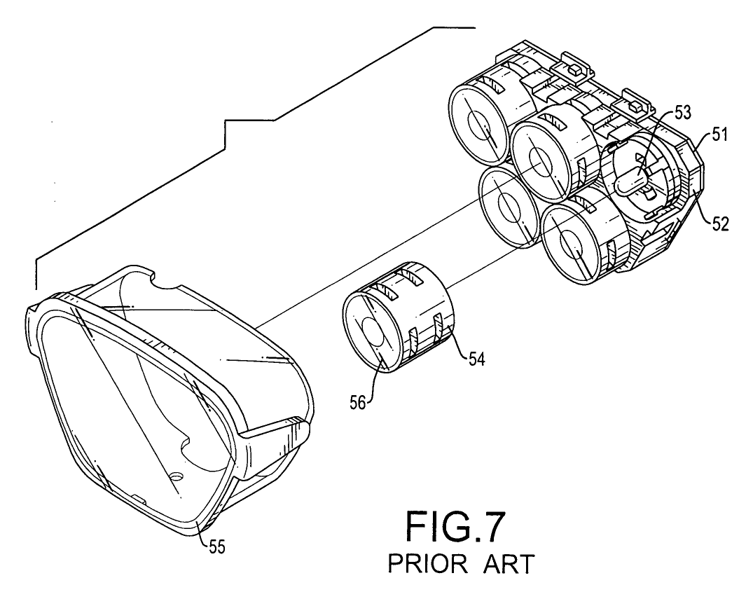

With further reference to FIG. 3, the LEDs (11) are respectively received in the corresponding bores (22) and extend into the reflecting cavities (21), and the integrated lenses (31) correspond respectively to the reflecting cavities (21). Because each reflecting cavity (21) and each lens (31) independently correspond to one specific LED (11), the modalities of the reflecting cavity (21) and the lens (31) can be designed and made most efficient in optics for that specific light source, i.e. that specific LED, and without interference with other light sources, i.e. other LEDs (11), on the circuit board (10). This will enhance the performance of the lighting device in converging light and controlling the light distribution pattern in a certain direction. Second, because the depth of the reflecting cavities (21) are larger than the length of the LEDs (11), and thus the cavities (21) fully enclosure surrounding the outer sides of the LEDs (11). Consequently, the light emitted from the LEDs (11) will not diffuse sideward and will be converged to the frontward direction. Third, from the depiction of FIG. 3, it is noted that each lens (31) is closely adjacent to the corresponding reflecting cavity (21) such that ensures the frontward light, either directly from the LEDs (11) or reflected by the reflecting cavities, to pass through the lenses (31) and thus be controlled by the lenses (31). This will further enhance the performance of the lighting device in converging light and controlling the light distribution pattern to a certain direction. In addition, while enhancing the light converging performance, the structure of the lighting device in accordance with the present invention is remained simple and the production cost is relatively low.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light emitting diode (LED) lighting device with light converging effect comprising:
a circuit board having multiple light emitting diodes (LEDs);
a light converging base securely connected to the circuit board and having multiple reflecting cavities defined in the light converging base, and each reflecting cavity having
a bore defined in a bottom of the reflecting cavity and corresponding to and receiving one of the LEDs; and
a depth are larger than a length of the corresponding LED; and
a cover combined with the light converging base to enclose the LEDs.

2. The LED lighting device as claimed in claim 1, wherein the cover further has multiple integrated lenses corresponding respectively to the reflecting cavities so that the light from the LEDs is further converged and controlled by the lenses.
